(19) United States
(12) Patent Application Publication
(10) Pub. No.: US 2019/0213623 A1
(43) Pub. Date: Jul. 11, 2019

(54) SYSTEM FOR PREDICTING FUTURE PURCHASE USING SEQUENCE PATTERN MINING OF CREDIT/DEBIT DATA

(71) Applicant: AFFINITY SOLUTIONS, INC., NEW YORK, NY (US)

(72) Inventors: AKHILA NAGULA, CLIFTON, NJ (US); NIPUN PALEKAR, MANHASSET, NY (US); GEORGE J. WADE, GLEN ROCK, NJ (US)

(21) Appl. No.: 15/868,141

(22) Filed: Jan. 11, 2018

(51) Int. Cl. G06Q 30/02; G06K 7/10; G06Q 20/20

(52) U.S. Cl. CPC G06Q 30/0224; G06Q 20/204; G06K 7/10366

(57) ABSTRACT

A system for managing generation of an electronic coupon (eCoupon) includes a terminal configured to process a credit/debit card to determine a card number of the credit/debit card; and computer server configured to generate a plurality of transactions from a pool of credit/debit card data, perform sequence pattern mining on the transactions to determine a sequence likely to result in an amount of spending in a pre-defined spending category within a subsequent period of time that exceeds a pre-defined spend threshold, receive the card number across a computer network from the terminal, and generate the eCoupon when existing purchases by the card number include the sequence.

### BACKGROUND

### 1. Technical Field

Embodiments of the inventive concept disclosed herein relate to sequence pattern mining, and more particularly to systems that use results of sequence pattern mining to predict future events and generate a coupon.

### 2. Discussion of Related Art

Targeting or audience selection is typically one of the most valuable drivers of marketing efficiency and success. Traditional methodologies used to develop audiences through statistical modeling use logistic regression or Recency, Frequency, Monetary (RFM) segmentation approaches. These methodologies are generally successful in predicting the probability of an event occurring. However, these techniques do not predict the timing of the event.

Market basket analysis studies the buying behavior of customers by searching for sets of items frequently purchased either together or in sequence. However, access to information about the individual items purchases may be limited. For example, the credit card transaction data resulting from the purchase include only the total amount purchased, but not information identifying the individual items purchased. Thus, a traditional market basket analysis cannot be performed on credit/debit card transaction data to predict whether the customer is likely to purchase a particular item at a future date.

### SUMMARY

According to an exemplary embodiment of the invention, a system for managing generation of an electronic coupon (eCoupon) is provided. The system includes a terminal configured to process a credit/debit card to determine a card number of the credit/debit card and a computer server configured to generate a plurality of transactions from a pool of credit/debit card data, perform sequence pattern mining on the transactions to determine a sequence likely to result in an amount of spending in a pre-defined spending category within a subsequent period of time that exceeds a pre-defined spend threshold, receive the card number across a computer network from the terminal, and generate the eCoupon when existing purchases by the card number include the sequence.

In an embodiment, each transaction includes a customer ID associated with a card number of a credit/debit card, a time period when a purchase occurred, and at least one item ordered by time, wherein each item indicates a merchant category code (MCC) associated with the purchase and one of a plurality of available spending levels.

In an embodiment, the plurality of available spending levels are generated by calculating an average timeframe expenditure in the MCC by each card number associated with the pool, calculating a minimum of the calculated average timeframe expenditures, calculating a maximum of the calculated average timeframe expenditures, generating a spending range bounded by the minimum and the maximum, dividing the spending range by a non-zero divisor to generate a plurality of sub-ranges, and assigning each sub-range to a unique one of the available spending levels.

In an embodiment, the sequence includes a sequence of one or more of the items from one or more of the transactions.

In an embodiment, the predefined spending category indicates one or more merchant category codes.

In an embodiment, the server sends the eCoupon to the terminal across the computer network, and the terminal is configured to print a coupon based on the eCoupon.

In an embodiment, the terminal includes a card swipe to process the credit/debit card.

In an embodiment, the terminal includes a radio frequency identifier (RFID) reader, and the terminal processes the credit/debit card by controlling the RFID reader to read the card number from an application of a smartphone.

In an embodiment, the terminal includes a barcode scanner configured to scan a barcode including the card number to process the credit/debit card.

In an embodiment, the pool of credit/debit card data includes a plurality of rows of data, where each row includes a card number, a date, a merchant category code (MCC), and a total amount spent in the MCC.

In an embodiment, the terminal is a point of sale (POS) terminal.

In an embodiment, the POS terminal sends the card number to the computer server after the card number is used to complete a purchase at the POS terminal.

According to an exemplary embodiment of the invention, a computer-implemented method for managing distribution of an electronic coupon (eCoupon) is provided. The method includes: generating a plurality of transactions from a pool of credit/debit card data, wherein each transaction includes a customer ID associated with a card number of a credit/debit card, a time period when a purchase occurred, and at least one item ordered by time, wherein each item indicates a merchant category code (MCC) associated with the purchase and one of a plurality of spending levels; performing sequence pattern mining on the transactions to determine a sequence likely to result in an amount of spending in a pre-defined spending category within a subsequent period of time that exceeds a pre-defined spend threshold; and outputting the eCoupon when existing purchases of a received card number include the sequence.

In an embodiment, the outputting includes transmitting the eCoupon across a network to a terminal configured to print a coupon based on the eCoupon.

In an embodiment, the outputting includes transmitting the eCoupon across a network to an application of a Smartphone configured to present the eCoupon on a display of the Smartphone.

In an embodiment, the generating includes: calculating an average timeframe expenditure in the MCC by each card number associated with the pool; calculating a minimum of the calculated average timeframe expenditures; calculating a maximum of the calculated average timeframe expenditures; generating a spending range bounded by the minimum and the maximum; dividing the spending range by a non-zero divisor to generate a plurality of sub-ranges; and assigning each sub-range to a unique one of the available spending levels.

In an embodiment, the sequence includes a sequence of one or more of the items from one or more of the transactions.

In an embodiment, the sequence pattern mining excludes an item from the sequence pattern mining that indicates a MCC that appears in greater than a pre-defined percentage of the transactions.

According to an exemplary embodiment of the invention, a method for predicting a future purchase is provided. The method includes: generating a plurality of transactions from a pool of credit/debit card data, wherein each transaction includes a customer ID associated with a card number of a credit/debit card, a time period when a purchase occurred, and at least one item ordered by time, wherein each item indicates a merchant category code (MCC) associated with the purchase and one of a plurality of spending levels; performing sequence pattern mining on the transactions to determine a sequence likely to result in an amount of spending in a pre-defined spending category within a subsequent period of time that exceeds a pre-defined spend threshold; and determining that a purchase in the pre-defined spending category will occur within the subsequent period of time when credit/debit card data of a received card number includes the sequence.

In an embodiment, the generating includes: calculating an average timeframe expenditure in the MCC by each card number associated with the pool; calculating a minimum of the calculated average timeframe expenditures; calculating a maximum of the calculated average timeframe expenditures; generating a spending range bounded by the minimum and the maximum; dividing the spending range by a non-zero divisor to generate a plurality of sub-ranges; and assigning each sub-range to a unique one of the available spending levels.

### BRIEF DESCRIPTION OF THE FIGURES

The inventive concept will become apparent from the following description with reference to the following figures, wherein like reference numerals refer to like parts throughout the various figures unless otherwise specified, and wherein:

FIG. 1 illustrates a system for generating a coupon according to an exemplary embodiment of the invention;

FIG. 2 illustrates a kiosk server of the system according to an exemplary embodiment of the invention;

FIG. 3 illustrates a coupon generation server of the system according to an exemplary embodiment of the invention;

FIG. 4 illustrates sample credit/debit card data for two credit/debit cards that may be operated on by the coupon generation server;

FIG. 5 illustrates sample transactions created by embodiments of the coupon generation server;

FIG. 6 illustrates a method of generating the available MCC spend levels for each credit/debit card, according to an exemplary embodiment of the invention;

FIG. 7 illustrates a method of performing sequence pattern mining on the credit/debit card data using the available MCC spend levels; and

FIG. 8 shows an example of a computer capable of implementing one or more of the servers according to an exemplary embodiment of the invention.

### DETAILED DESCRIPTION OF THE EXEMPLARY EMBODIMENTS

Hereinafter, exemplary embodiments of the inventive concept will be described more fully with reference to accompanying drawings. Below, details, such as detailed configurations and structures, are provided to aid a reader in understanding embodiments of the inventive concept. Therefore, embodiments described herein may be variously changed or modified without departing from embodiments of the invention.

At least one embodiment of the invention was developed to identify an individual who is likely to spend greater than or equal to a pre-defined amount (e.g., $1000.00) in a pre-defined spending category (e.g., Home Improvement) within a pre-defined time period (e.g., within the next 4 weeks), using credit/debit card data of numerous customers (e.g., thousands, millions, etc.) and sequential pattern mining.

At least one embodiment of the invention provides a coupon of a merchant that is associated with the pre-defined spending category to the identified individual. The coupon may be used by the individual to purchase items in the pre-defined spending category. A merchant that is associated with the pre-defined spending category may supply goods or services that are classified as being part of the pre-defined spending category. For example, if the pre-defined spending category is home improvement, the goods could include tiles, lumber, paint, etc. and the services could include laying tile, roof repairs, painting, etc.

Sequential pattern mining is based on association rule learning and finds patterns in commonly occurring episodic events. Sequential pattern mining makes use of a sequential database D_{S}, which stores several transactions. For example, each transaction T could include a customer identifier (e.g., based on a credit/debit card number) and a set of items involved in the transaction T. For example, I={iᵢ, i₂, . . . , iₘ) represents a unique set of items. An itemset is a non-empty subset of items, and an itemset with k items is referred to as a k-itemset. A sequence S can be an ordered list of itemsets based on a timestamp or an ordered list of items spanning multiple itemsets. The support of a sequence S in a sequence database D_{S} is the number of transactions that contain the sequence S. A sequence S is considered a frequent sequential pattern when its support is greater than or equal to a pre-defined minimum support threshold.

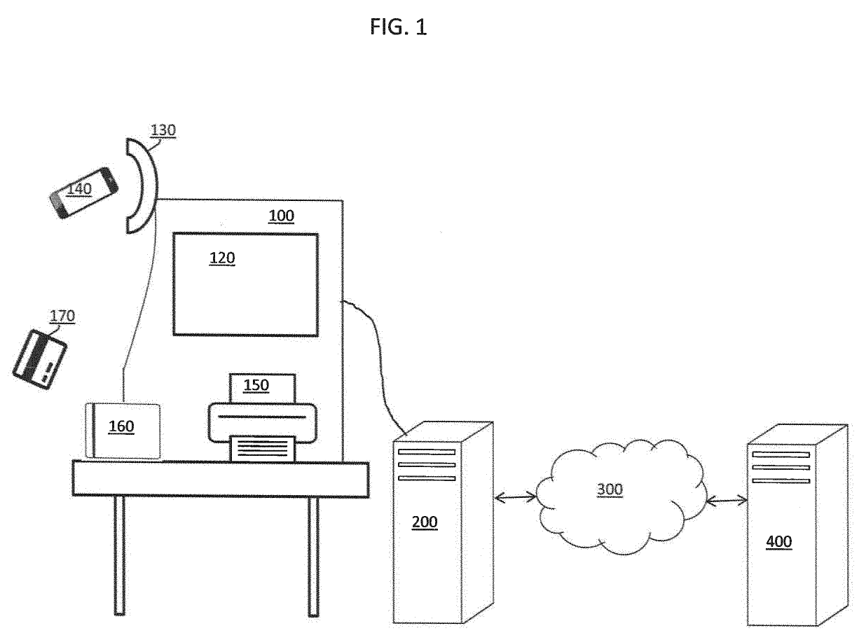

FIG. 1 illustrates a system for generating a coupon according to an exemplary embodiment of the inventive concept. The system includes a kiosk 100, a kiosk server 200, and a coupon generation server 400. The kiosk 100 includes a display 120, a scanner 130, a printer 150, and a card reader 160. The kiosk 100 is controlled by the kiosk server 200, which is a computer. In an embodiment, the kiosk 100 is a terminal. For example, the kiosk could be a point-of-sale (POS) terminal.

The display 120 may present information instructing a user to scan their smartphone 140 or swipe their credit/debit card 160 to receive a coupon.

In an embodiment, the scanner 130 is configured to scan bar codes such as quick response codes displayed by the smartphone 140, and send a result of the scan to the kiosk server 200. In an embodiment, the bar code includes information that uniquely identifies the user with a customer identifier (ID). For example, the customer ID may be a credit/debit card number of a credit/debit card 170 used by the user. In an embodiment, the user has previously downloaded an application to their smartphone 140 that displays the bar code, which is scanned by the scanner 130. In an embodiment where the kiosk is a POS terminal, the scanner 130 is additionally used to scan the bar codes of merchandise so a user can purchase the merchandize. For example, the coupon may be presented after the merchant or the user is done scanning merchandise for the user and the user or merchant has processed (e.g., by swipe or wirelessly through RFID and an application on a smartphone) a credit/debit card of the user to pay for the scanned merchandise.

The scanner 130 may alternately or additionally include a radio frequency identifier (RFID) reader such as a near field communication (NFC) reader to communicate with the smartphone 140. For example, when the smartphone 140 has an NFC transmitter/reader, and the smartphone 140 is brought in close proximity to the scanner 130, the scanner 130 is able to communicate with the smartphone 140 using NFC and accordingly, is able to receive a message including the customer ID from the Smartphone 140 wirelessly.

The scanner 130 may be omitted in an alternate embodiment, which only includes the card reader 160.

The card reader 160 may include a credit/debit card swipe and/or a credit/debit card chip reader. When the user swipes a credit/debit card 170 in the card swipe or inserts the credit/debit card 170 in the card chip reader, the card reader 160 extracts the credit/debit card number and sends results of the extraction to the kiosk server 200. The credit/debit card number may be used as the customer ID or to generate the customer ID.

The card reader 160 may be omitted in an alternate embodiment, which only includes the scanner 130.

The kiosk server 200 controls all of the peripherals of the kiosk 100 and communicates with the coupon generation server 400 across a network 300 (e.g., the Internet, a cellular network). The peripherals include the display 120, the scanner 130, the card reader 160, and the printer 150. For example, the kiosk server 200 may include hardware sufficient to enable itself to communicate with the coupon generation server 400 and other computers or websites.

The kiosk server 200 may be configured to send the customer ID in a secure manner (e.g., encrypted) to the coupon generation server 400. If the coupon generation server 400 deems that the customer ID is due to receive a coupon, the coupon generation 400 sends a computer message including the coupon across the network 300 to the kiosk server 200. The kiosk server 100 can print the coupon using the printer 150 or send the coupon to the application on the smartphone 140. The printed coupon can be presented to a merchant for a discount on goods or services provided by the merchant. The coupon sent to the application is available within an application on the smartphone 140 as an electronic coupon (e-Coupon). The e-Coupon can be presented on a display of the smartphone 140 by starting the application on the smartphone 140 and redeemed by showing the displayed e-Coupon to the merchant. For example, the e-Coupon can be redeemed when a merchant uses a merchant scanning device to scan the e-Coupon or manually enters in a code illustrated on the e-Coupon.

In an embodiment, the printer 150 is omitted.

The generation of the coupon will be discussed in more detail later in this document.

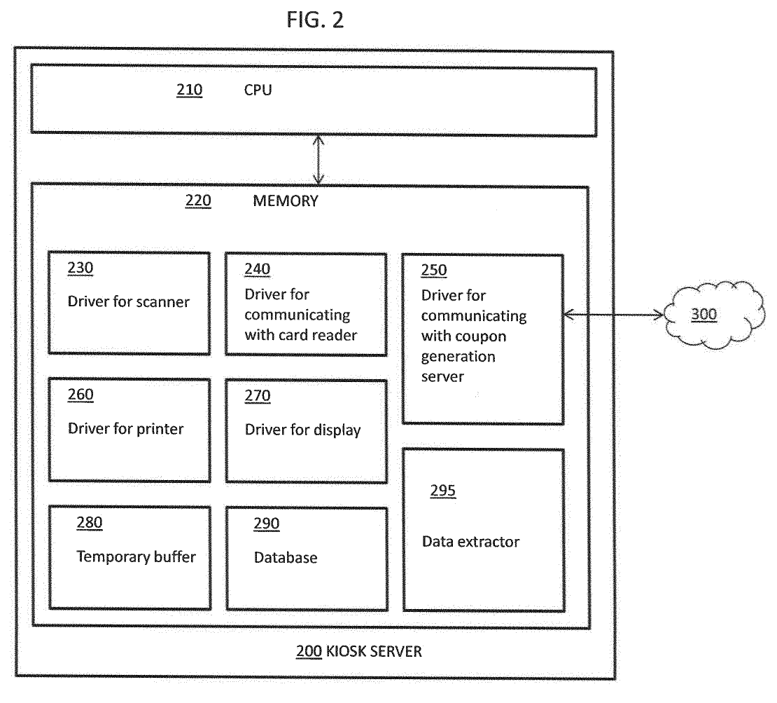

FIG. 2 illustrates the kiosk server 200 of FIG. 1 according to an exemplary embodiment of the invention. The kiosk server 200 includes a memory 220 storing a driver 230 for communicating with the scanner 130, a driver 240 for communicating with the card reader 160, a driver 250 for communicating with the coupon generation server 400, a driver 260 for communicating with the printer 150, a driver 270 for communicating with the display 120. The kiosk server 200 may include a temporary buffer 280 and a database 290. The temporary buffer 280 may be used to temporarily store scan data extracted from scanning of the credit/debit card or scanning of the smartphone 140.

The memory 220 may additionally include a data extractor 295 configured to perform an operation on the scan data to generate data of the credit/debit card such as the credit/debit card number, for output to the driver 250. The credit/debit card number may be stored in the temporary buffer 280. [0050]In an embodiment, the driver 250 is configured to encrypt the credit/debit card number and send the encrypted data in a first message to the coupon generation server 400. The first message may additionally include a kiosk identifier that uniquely identifies the kiosk 100 from other kiosks or the kiosk server 200 from other kiosk servers. The driver 250 is configured to receive a second message from the coupon generation server 400 in response to sending the first message. The second message may be encrypted. In an embodiment, the second message includes the credit/debit card number and a coupon, the driver 250 decrypts the second message to determine the included credit/debit card number. If the included credit/debit card number matches the temporarily stored credit/debit card number, the driver 250 may output the coupon to the driver 260 for local printing of the coupon or output the coupon to the application of the smartphone 140 for generation of the e-coupon. The coupon (or e-coupon) may be stored in the database 290. In another embodiment, instead of the coupon generation server 400 responding with the second message, the coupon generation server 400 sends the coupon directly to the application of the smartphone 140. When the user is not entitled to a coupon, the second message may include data indicating there is no coupon currently available. For example, based on the spending habits of the customer of the credit/debit card, the coupon generation server 400 could conclude that no coupon is warranted. The CPU 210 of the kiosk server 200 is configured to execute the software units stored in the memory 220. The software units include drivers 230-270 and data extractor 295.

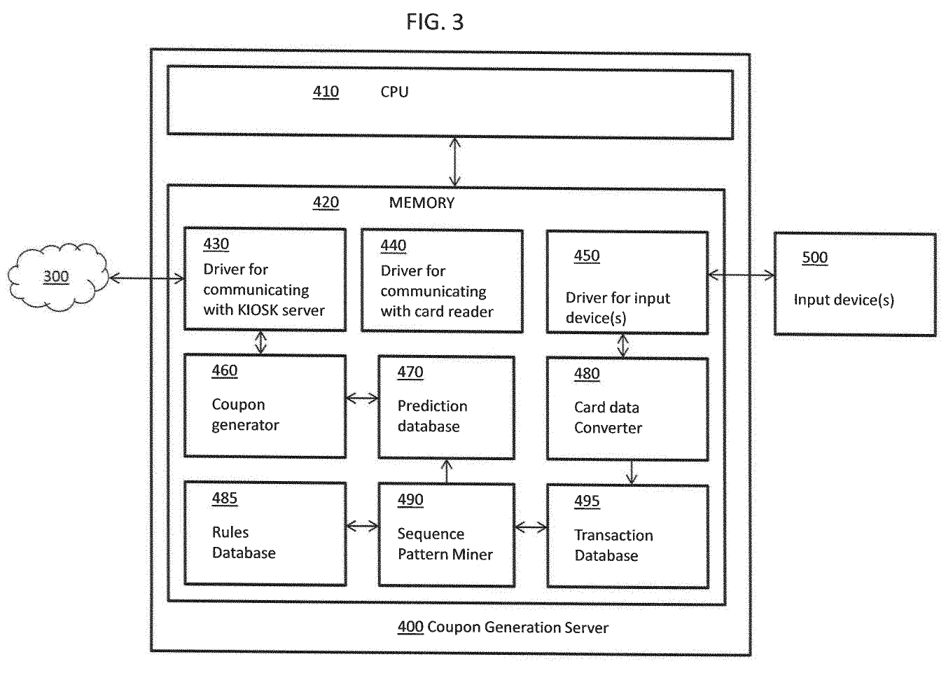

FIG. 3 illustrates the coupon generation server 400 according to an exemplary embodiment of the invention. The coupon generation server 400 includes a CPU 410 and a memory 420 storing one or more software units. The CPU 410 is configured to execute the software units. The memory 420 includes a driver 430 for communicating with the Kiosk server 200, a driver 440 for communicating with the card reader 460, a driver 450 for communicating with one or more input devices 500, a coupon generator 460, a prediction database 470, a card data converter 480, a rules database 485, a transaction analyzer 490, and a transaction database 495.

Credit/debit card data of multiple customers can be loaded on the coupon generation server 400 using one or more input device(s) 500. For example, when the input device 500 is a compact disk (CD) drive, the credit/debit card data stored on a CD is loaded into the CD drive controlled by the driver 450. For example, when the input device 500 is a USB port, the credit/debit card data stored in a flash thumb drive can be inserted into the USB port.

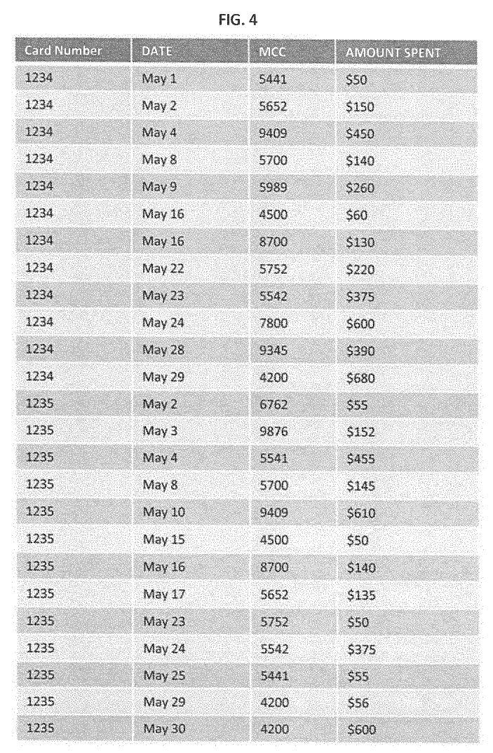

FIG. 4 is an example of the credit/debit card data for a first credit card number 1234 and a second credit card number 1235 that occurred as a result of purchases performed during a single month. For example, each entry of FIG. 4 identifies the credit/debit card number of the card used to make the purchase, the date of the purchase, a merchant category code (MCC) of the merchant where the purchase occurred, and a total amount spent. Since a customer can make multiple purchases on a same data at multiple different stores with different associated MCC, there may be multiple MCC entries for a given data. The card data converter 480 converts the credit/debit card data into a form (e.g., transactions) that can be mined using sequence pattern mining according to an exemplary embodiment of the invention, and stores the converted data into the transaction database 495.

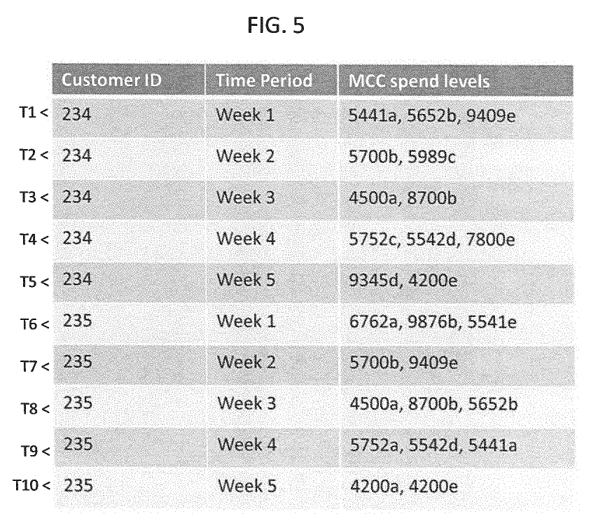

FIG. 5 is an example of the converted data after performing a method on the data of FIG. 4. FIG. 5 illustrates transactions derived from the data of FIG. 4 associated with card number 1234 and card number 1235. Each row of the data is considered a different transaction. Each transaction includes a customer ID (e.g., a number derived from a credit/debit card number), a time period (e.g., Week 1, Week 2, Week 3, etc.), and time ordered MCC spend levels (e.g., oldest to newest) that occurred during the time period. For example, customer ID 234 was derived from credit/debit card number 1234 and customer ID 235 was derived from credit/debit card number. The time ordered MCC spend levels of a given transaction (e.g., a given row) may be interpreted as items. An MCC spend level indicates that a purchase occurred in a given MCC and a relative amount spent in the MCC as compared to other customers that also spend in the same MCC. For example, an MCC spend level may provide this information by including a given MCC (e.g., 5441, 5652, etc.) and a label (e.g., level ‘a’, level ‘b’, level ‘c’, level ‘d’, level ‘e’, etc.) indicating a spend level of the given MCC. For example, spend level ‘a’<spend level ‘b’<spend level ‘c’<spend level ‘d’<spend level ‘e’. The MCC spend level in a given transaction is selected from a list of available MCC spend levels for an MCC of the MCC spend level based on the amount spent by the customer ID (e.g., a credit/debit card number) of the given transaction in the MCC. For example, if the amount spent in the MCC falls within the first spend level ‘a’, and the MCC is 5441, then the MCC spend level would be 5441a. While FIG. 5 illustrates each transaction including two or three items (e.g., MCC spend levels), the invention is not limited thereto. For example, each transaction may include only a single MCC spend level or more than three MCC spend levels..

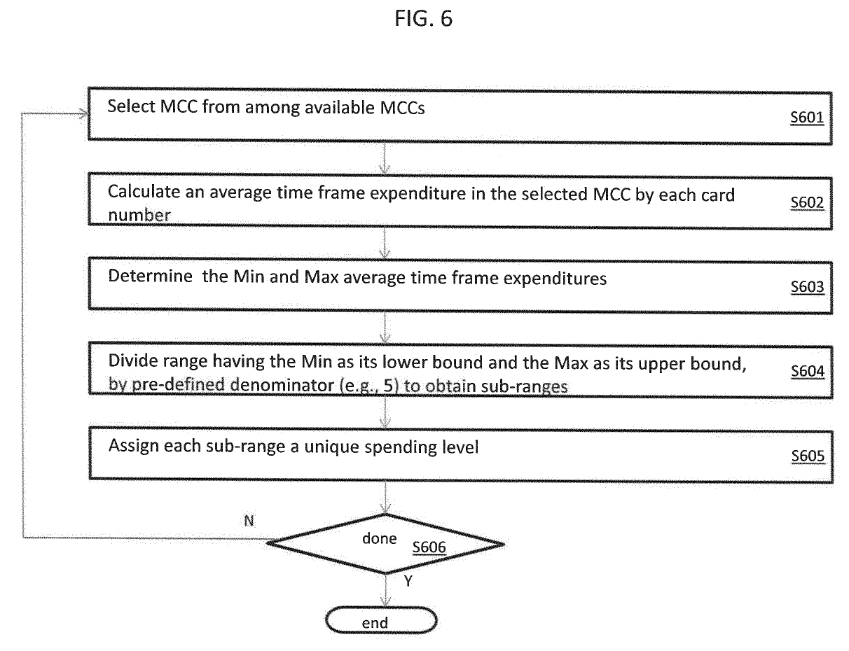

FIG. 6 illustrates a method of generating the list of available spend levels for a given MCC when the time period is a single week. The method includes selecting an MCC from the available MCCs (S601). For example, the memory 420 may store a list of available MCCs. The list of available MCCs may have been previously entered into a database in the memory 420 using the input devices 500. The list of available MCCs may have been automatically determined by analyzing the credit/debit card data.

The method further includes calculating an average timeframe expenditure in the selected MCC by each card number in the credit/debit card data (S602). In an embodiment, the average timeframe expenditure is an average daily, weekly, bi-weekly, or monthly amount spent by each card number in the selected MCC. For example, if the credit/debit card with card number 1234 and customer ID 234 spends $100 on MCC 5441 on odd weeks and $200 on MCC 5441 on even weeks, then the average weekly spend of customer ID 234 on MCC 5441 is $150. For example, if the credit/debit card with card number 1235 and customer ID 235 spends $200 on MCC 5441 on odd weeks and $300 on MCC 5441 on even weeks, then the average weekly spend of customer ID 235 on MCC 5441 is $250. For example, if the credit/debit card with card number 1236 and customer ID 236 spends $300 on MCC 5441 on odd weeks and $400 on MCC 5441 on even weeks, then the average weekly spend of customer ID 236 on MCC 5441 is $350. Thus, the method would determine weekly amounts of spend such as $150, $250, and $350.

The method then includes determining the Min and Max average timeframe expenditures (S603). For example, using the above data, the method would conclude $150 to be the minimum average week amount spent and $350 to be the maximum average weekly amount spent.

Then the method includes dividing a range having the minimum as its lowest bound and the maximum as its upper bound by a pre-defined denominator (e.g., at least 2, and preferably 5) to obtain a number of sub-ranges (S604). For example, dividing a range having a lower bound of $150 and an upper bound of $350 by 5 would result in a first sub-range of $150 to $190, a second sub-range of $190 to $230, a third sub-range of $230 to $270, a fourth sub-range of $270 to $310, and a fifth sub-range of $310 to $350.

Then, the method includes assigning each sub-range a unique spending level (S605). For example, the sub-range of $150 to $190 could be assigned to spending level ‘a’, the sub-range of $190 to $230 could be assigned to spending level ‘b’, etc.

The method then determines whether it has gone through all MCCs (S606). If the method has not gone through all the MCCs, it selects a next one of the MCCs and then the process (e.g., S602-S606) is repeated for the next MCC. The sub-ranges for a given MCC can be used to generate the available MCC spend levels for the given MCC.

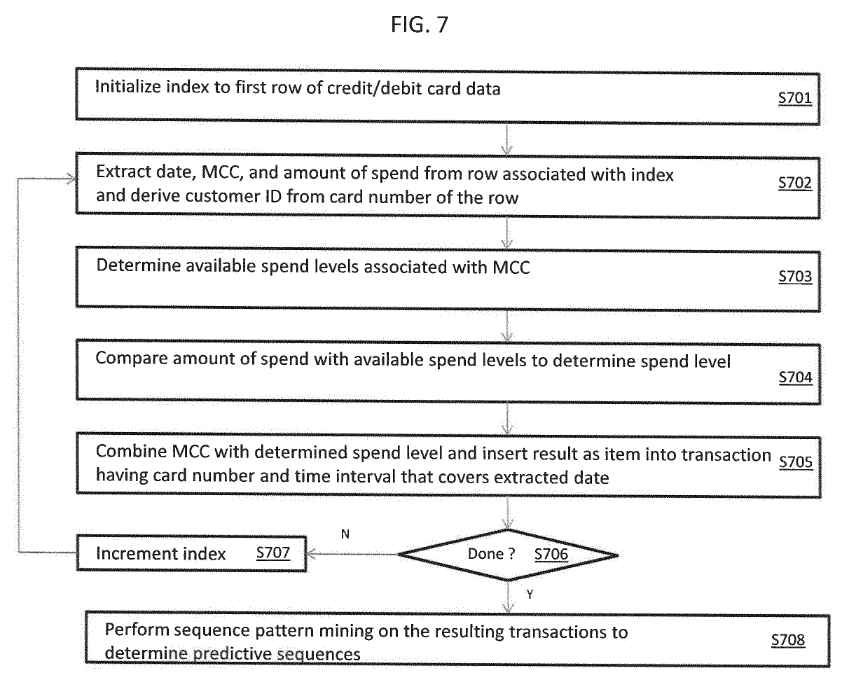

FIG. 7 illustrates a method of performing sequence pattern mining on the credit/debit card data (e.g., see FIG. 5) to determine predictive sequences according to an exemplary embodiment of the invention.

The method includes initializing an index to a value pointing to the first row of credit/debit card data (S701). For example, when the credit/debit card data is in a computer file, and organized into rows as shown in FIG. 4, the index is initially set to a value pointing to the first row.

The method includes extracting the date, the MCC and the amount of spend from the row associated with the index and deriving customer ID from card number of the row (S702). For example, as shown in FIG. 4 and FIG. 5, the method would extract a date of May 1, an MCC of 5441, and a $50 amount of spend from the first row, and derive a customer ID of 234 from the 1234 card number of the first row.

The method includes determining the available spend levels associated with the MCC (S703). For example, the available spend levels may be determined using the method of FIG. 6.

The method further includes comparing the amount of spend with the available spend levels (e.g., levels a-e) associated with the MCC to determine the current spend level (S704). For example, if the extracted MCC is 5441, the extracted amount of spend is $50, and the level ‘a’ spend level is between $40 and $60 (e.g., greater than $40 and less than $60), the method would determine that the current spend level is a level ‘a’ spend level. The method further includes combining the extracted MCC with the determined spend level and inserting the result of the combining as an item into a transaction associated with the customer ID and a time interval that covers the extracted date (S705). For example, as shown in FIG. 5, the ‘5441’ of the determined MCC is combined with the ‘a’ of the determined spend level and inserted as an item (e.g., an MCC spend level) into the transaction having a Customer ID (e.g., 234) that corresponds to the card number (e.g., 1234) having a time period (e.g., Week 1) that covers the extracted date. The items in a given transaction are in time order. Since MCC spend level of 5441a occurred on May 1 before the other MCC spend levels, FIG. 5 illustrates 5441a occurring in time before 5652b and 9409e.

The method then determines whether it is done going through the entries of credit/debit card data (S706). If the method determines it is not done, it increments the index (S707), and proceeds to step S702. For example, if the index is set to 1 to point to the first row, then the index would be incremented to 2, and extract the data, MCC, and amount of spend on the second row of FIG. 4. Steps S701-S706 are performed until all of the credit/debit card data has been processed into transactions. For example, operating steps S701-S706 on the credit/debit card data of FIG. 4 resulted in the 10 transactions shown in FIG. 5, where some of the transactions include 3 items (e.g., MCC spend levels) and some of the transactions include 2 items. However, a transaction is not limited to 2 or 3 items. For example, a transaction could include a single item or more than 4 items. The steps S701-S706 may be performed by the card data converter 480.

In an exemplary embodiment, the MCC levels occurring above a pre-determined percentage are eliminated from the transactions after all the transactions have been determined. In an embodiment, the pre-defined percentage is 20%. For example, if it is determined that an MCC level of 5441a occurs in more than 20% of the transactions, then the MCC spend level is removed from the items of the transactions. For example, if the system has stored 100 transactions, and 21 of the transactions include an MCC level of 5441a, then the MCC level is removed. This removal may overcome the challenge of large deviations in support levels. In an alternate embodiment, rather than remove the MCC level that occurs more often than the pre-defined percentage of the transactions, the corresponding MCC level is marked so that it is not used in a subsequent sequence pattern mining. In this embodiment, each transaction further includes a flag indicating whether it is to be used in sequence pattern mining (i.e., flag is set) or whether it is not to be used in the sequence pattern mining (i.e., flag is cleared). The flag can be updated in a transaction when the pre-defined percentage is changed to a different value that causes the transaction to be filtered in or out of the subsequent sequence pattern mining.

The method then includes performing sequence pattern mining on the items (e.g., the MCC levels) in the transactions (e.g., see FIG. 5) to determine predictive sequences S (S708). The step S708 may be performed by the sequence pattern miner 490. The sequence pattern miner 490 may determine whether data of the transactions correspond to sequences S that result in a desired spending state (e.g., customer spending more than a threshold amount of money in a pre-defined spending category within a future time period from a time period of the analyzed sequences). Referring to FIG. 5, a first transaction Ti includes itemset {5441a, 5652b, 9409e} and a sixth transaction T6 includes itemset {6762a, 9876b, 5541e}. An example of a first sequence S₁ could be 5441a->5652b->9409e->5700b and an example of a second sequence S₂ could be 6762a->9876b->5541e. The pre-defined spending category may be defined as including one or more MCC levels or one or more MCCs with a corresponding amount spent in the MCCs. For example, if the pre-defined spending category includes an MCC 9345 and a corresponding target spend of $1000, since the first sequence S₁ resulted in a Week 5 MCC spend level of MCC 9345d, when 9345d exceeds $1000, it would indicate that the sequence S₁ is likely to result in a spend in an MCC 9345 exceeding the target spend (i.e., it may be predictive). For example, since the second sequence S₂ did not result in a future spend in an MCC of 9345, it could indicate that the sequence S2 does not result in an MCC 9345 exceeding the target spend (i.e., does not result in the target spend). In an embodiment, the sequence (e.g., S₁) that is determined to be potentially predictive is extracted for storage in a prediction database 470. The extraction may be performed by the sequence pattern miner 490.

The sequence pattern miner 490 may consider rules in the rules database 485 in determining whether a sequence meeting the above-described criteria is to be filtered out or retained. In an embodiment, the rules database includes a rule that indicates the minimum MCCs that are required to retain a sequence. In an embodiment, rules with longer chains are favored over rules with shorter chains. In an embodiment, rules with high diversity of MCC are favored over rules of low diversity of MCC. For example, if a first rule of 5411=>5411=>5525->desired spending state is present and a second rule of 5411=>5942=>5542−>desired spending state is present, sequences satisfying the second rule can be retained over sequences satisfying the first rule since it has more different types of MCC. Please note that MCC1=>MCC2 means that a purchase in MCC2 occurred after a purchase in MCC1. For example, a rule such as 5411=>5942=>5542−>“desired spending state” means that a purchase in MCC 5942 occurred after a purchase in MCC 5411 and a purchase in 5542 occurred after the purchase in MCC 5942, and the sequence of purchases results in the desired spending state (e.g., at least $1000 of spend in a home improvement category). The rules may include MCC levels in addition to or instead of MCCs. Thus, if a single transaction or a series of transactions of a same customer includes MCC levels in the same order as one of the rules, the sequence can be extracted and stored in the prediction database 470 as being potentially predictive.

In an embodiment, rules are chosen that appropriately trade off Confidence vs. Lift. The Confidence of a rule is the number of times the rule was found to be true in the data. For example, if a first rules predicts a desired spending state when a first sequence of MCC spending levels occur, the first sequence occurs 20 times in the data, and the desired spending state occurred in only 10 of those 20 times, the Confidence in the rule would be 50%. The Lift of rule is the measure of the performance of rule at predicting cases to have an enhanced response. For example, if a random sequence is generated, and that random sequence occurs 20 times in the data and the desired spending state occurred in only 5 of those 20 times, then the Lift would be 2.0. In an embodiment, rules with Lift<1.5 are not used and rules with Lift>1.5 are prioritized in descending order of confidence. In an embodiment, preference is given to rules with one or more certain spend levels among the available levels (e.g., spend ‘a’ and spend level ‘e’).

The sequences retained in the prediction database 470 can be used by the coupon generator 460 to determine whether to generate a coupon. If a customer swipes their credit/debit card at the kiosk 100, the kiosk server 200 sends either the card number of the credit/debit card or a customer ID derived from the card number to the coupon generation server 400. The driver 430 for communicating with the kiosk server 200 receives the sent card number or customer ID, and analyzes credit card data of the sent card number or customer ID to see if it includes any of the sequences stored in the prediction database 470. If the analyzed credit card data does include one of the sequences, then a coupon is generated by the coupon generator 450 for the pre-defined spending category associated with the one sequence, and the driver 430 sends the coupon to the driver 250 of the kiosk server 200.

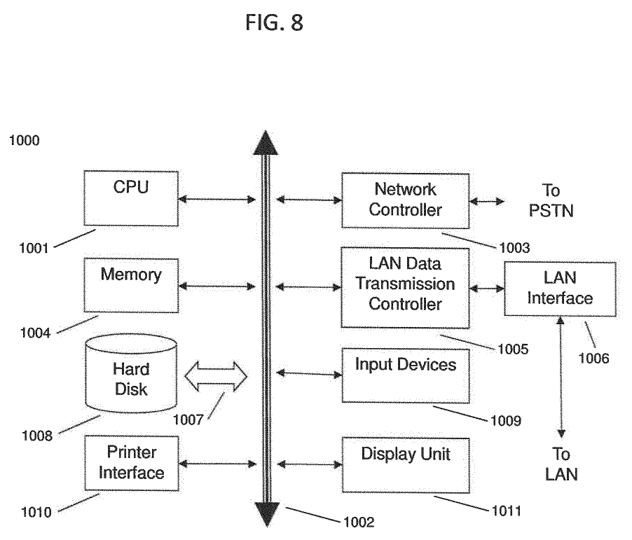

FIG. 8 shows an example of a computer system which may implement a method and system of the present disclosure, for example, may embody the kiosk server 200 or the coupon generation server 400. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

A significant advantage of an embodiment of the inventive concept is that it predicts from the available transaction data whether an event is likely to occur (e.g., whether a product in a particular category of products will be purchased by a given consumer) and the precise time period during which the event will occur. Prior techniques such as logistic regression or recency, frequency, and monetary (RFM) segmentation approaches are unable to predict this precise time period. For example, if an embodiment of the inventive concept predicts that consumer A will be purchasing product B in time period C, it can give this information to retailer D so it knows to stock product B by period C and send out a related coupon or advertisement to consumer A just before period C to encourage them to shop at retailer D as opposed to another retailer. This saves the retailer money since they do not have to send out these advertisements at other time periods during which the consumer is not interested in buying a given product. This also saves the retailer space in their stores since they do not have to provide space for the given product until the predicted time period.

The predicted time period can also be used to improve the computer functionality of a computer that is used to send out targeted advertisements to consumers. For example, if the computer only knows that a group of consumers have an interest in a particular product, but does not know the precise time period of the purchase, the computer must periodically (e.g., monthly) send out advertisements (e.g., email electronic coupons) to the entire group. Thus, the computer wastes processing power and memory to send out advertisements during periods when the customers are not interested in a particular purchase. For example, if the computer emails an advertisement to all one million of its consumers each week requiring using 40% of its CPU (e.g., 410) and 20% of its main memory (e.g., 420), 40% of the CPU and 20% of the main memory can be freed up for other tasks upon using an embodiment of the invention that discovers that none of these consumers have any interest in products of the advertisement this week.

The various operations of methods described above may be performed by any suitable means capable of performing the operations, such as various hardware and/or software components, circuits, and/or modules. The software may comprise an ordered listing of executable instructions for implementing logical functions, and can be embodied in any processor-readable medium for use by or in connection with an instruction execution system, apparatus, or device, such as a single or multiple-core processor or processor-containing system. The functions may be stored in or transmitted over as one or more instructions or code on a tangible, non-transitory computer-readable medium.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A system for managing generation of an electronic coupon (eCoupon), the system comprising:
a terminal configured to process a credit/debit card to determine a card number of the credit/debit card; and
a computer server configured to generate a plurality of transactions from a pool of credit/debit card data, perform sequence pattern mining on the transactions to determine a sequence likely to result in an amount of spending in a pre-defined spending category within a subsequent period of time that exceeds a pre-defined spend threshold, receive the card number across a computer network from the terminal, and generate the eCoupon when existing purchases by the card number include the sequence.

2. The system of claim 1, wherein each transaction includes a customer identifier (ID) associated with a card number of a credit/debit card, a time period when a purchase occurred, and at least one item ordered by time, wherein each item indicates a merchant category code (MCC) associated with the purchase and one of a plurality of available spending levels.

3. The system of claim 2, wherein the plurality of available spending levels are generated by calculating an average timeframe expenditure in the MCC by each card number associated with the pool, calculating a minimum of the calculated average timeframe expenditures, calculating a maximum of the calculated average timeframe expenditures, generating a spending range bounded by the minimum and the maximum, dividing the spending range by a non-zero divisor to generate a plurality of sub-ranges, and assigning each sub-range to a unique one of the available spending levels.

4. The system of claim 2, wherein the sequence includes a sequence of one or more of the items from one or more of the transactions.

5. The system of claim 1, wherein the predefined spending category indicates one or more merchant category codes.

6. The system of claim 1, where the server sends the eCoupon to the terminal across the computer network, and the terminal is configured to print a coupon based on the eCoupon.

7. The system of claim 1, wherein the terminal includes a card swipe to process the credit/debit card.

8. The system of claim 1, wherein the terminal includes a radio frequency identifier (RFID) reader, and the terminal processes the credit/debit card by controlling the RFID reader to read the card number from an application of a smartphone.

9. The system of claim 1, wherein the terminal includes a barcode scanner configured to scan a barcode including the card number to process the credit/debit card.

10. The system of claim 1, wherein the pool of credit/debit card data includes a plurality of rows of data, where each row includes a card number, a date, a merchant category code (MCC), and a total amount spent in the MCC.

11. The system of claim 1, wherein the terminal is a point of sale (POS) terminal.

12. The system of claim 11, wherein the POS terminal sends the card number to the computer server after the card number is used to complete a purchase at the POS terminal.

13. A computer-implemented method for managing distribution of an electronic coupon (eCoupon), the method comprising:
generating, by a processor, a plurality of transactions from a pool of credit/debit card data, wherein each transaction includes a customer identifier (ID) associated with a card number of a credit/debit card, a time period when a purchase occurred, and at least one item ordered by time, wherein each item indicates a merchant category code (MCC) associated with the purchase and one of a plurality of spending levels;
performing, by the processor, sequence pattern mining on the transactions to determine a sequence likely to result in an amount of spending in a pre-defined spending category within a subsequent period of time that exceeds a pre-defined spend threshold; and
outputting, by the processor, the eCoupon when existing purchases of a received card number include the sequence.

14. The computer-implemented method of claim 13, wherein the outputting comprises the processor transmitting the eCoupon across a network to a terminal configured to print a coupon based on the eCoupon.

15. The computer-implemented method of claim 13, wherein the outputting comprises the processor transmitting the eCoupon across a network to an application of a Smartphone configured to present the eCoupon on a display of the Smartphone.

16. The computer-implemented method of claim 13, wherein the generating comprises:
calculating, by the processor, an average timeframe expenditure in the MCC by each card number associated with the pool;
calculating, by the processor, a minimum of the calculated average timeframe expenditures;
calculating, by the processor, a maximum of the calculated average timeframe expenditures;
generating, by the processor, a spending range bounded by the minimum and the maximum;
dividing, by the processor, the spending range by a non-zero divisor to generate a plurality of sub-ranges; and
assigning, by the processor, each sub-range to a unique one of the available spending levels.

17. The computer-implemented method of claim 13, wherein the sequence includes a sequence of one or more of the items from one or more of the transactions.

18. The computer-implemented method of claim 13, wherein sequence pattern mining excludes an item from the sequence pattern mining that indicates a MCC that appears in greater than a pre-defined percentage of the transactions.

19. A method for predicting a future purchase, the method comprising:
generating, by a processor, a plurality of transactions from a pool of credit/debit card data, wherein each transaction includes a customer identifier (ID) associated with a card number of a credit/debit card, a time period when a purchase occurred, and at least one item ordered by time, wherein each item indicates a merchant category code (MCC) associated with the purchase and one of a plurality of spending levels;
performing, by the processor, sequence pattern mining on the transactions to determine a sequence likely to result in an amount of spending in a pre-defined spending category within a subsequent period of time that exceeds a pre-defined spend threshold; and
determining, by the processor, that a purchase in the pre-defined spending category will occur within the subsequent period of time when credit/debit card data of a received card number includes the sequence.

20. The method of claim 19, wherein the generating comprises:
calculating, by the processor, an average timeframe expenditure in the MCC by each card number associated with the pool;
calculating, by the processor, a minimum of the calculated average timeframe expenditures;
calculating, by the processor, a maximum of the calculated average timeframe expenditures;
generating, by the processor, a spending range bounded by the minimum and the maximum;
dividing, by the processor, the spending range by a non-zero divisor to generate a plurality of sub-ranges; and
assigning, by the processor, each sub-range to a unique one of the available spending levels.
